(19) United States
(12) Patent Application Publication
(10) Pub. No.: US 2009/0031224 A1
(43) Pub. Date: Jan. 29, 2009

(54) METHOD, SYSTEM, AND COMPUTER PROGRAM PRODUCT FOR VISUALLY ASSOCIATING A STATIC GRAPHIC IMAGE AND HTML TEXT ON A WEB PAGE

(75) Inventor: David A. Budreau, Innisfil (CA)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/782,907

(22) Filed: Jul. 25, 2007

(51) Int. Cl. G06F 3/01

(52) U.S. Cl. 715/760

(57) ABSTRACT

A static graphic image on a web page is visually associated with hypertext markup language (HTML) text on the web page. A web page containing multiple static graphic images and HTML text associated with each static graphic image is displayed. Input indicating selection of a static graphic image or HTML text is received. The selection is indicated by movement of a cursor over at least a portion of a selected static graphic image, movement of the cursor over selected HTML text, or focusing on an area of a selected static graphic image or selected HTML text. In response to the input, the web page is displayed with selected HTML text or HTML text associated with a selected static graphic image highlighted with a visual cue on the web page and with the display of a selected static graphic image or a static graphic image associated with selected HTML text updated without moving to another area on the web page or moving to another web page.

### BACKGROUND

The present invention relates generally to data assistive imagery, and, in particular to visually associating a static graphic image and HTML text.

Currently, users often use a Hypertext Markup Language (HTML) image-map or an HTML anchor link to jump to a specific area of text after clicking on an area of or an entire graphic on a web page. Image maps allow authors to specify regions of an image or object and assign a specific action to each region, e.g., retrieve a document, run a program, etc. When the region is activated by a user “clicking” on it, the action is executed. A link allows a connection from one web resource to another. The link starts at the “source” anchor and points to the “destination” anchor, which may be any web source, e.g., an image, a video clip, a sound bit, a problem an HTML document, an element within an HTML document, etc. By “clicking” on the link, the destination web resource is retrieved.

Clicking on a graphic in a web page to jump to an area of text causes movement to another area of the webpage or to another webpage all together. There is no initial visual cue between the image and text that links the information together, offering additional context to the graphic or associating an area of an image to a written process or action described within HTML text on a particular web page.

### SUMMARY

According to an exemplary embodiment, a method, a system, and a computer program product are provided for visually associating a static graphic image on a web page with hypertext markup language (HTML) text on the web page. A web page containing multiple static graphic images and HTML text associated with each static graphic image is displayed. Input indicating selection of a static graphic image or HTML text is received. The selection is indicated by movement of a cursor over at least a portion of a selected static graphic image, movement of the cursor over selected HTML text, or focusing on an area of a selected static graphic image or selected HTML text. In response to the input, the web page is displayed with selected HTML text or HTML text associated with a selected static graphic image highlighted with a visual cue on the web page and with the display of a selected static graphic image or a static graphic image associated with selected HTML text updated without moving to another area on the web page or moving to another web page.

### BRIEF DESCRIPTION OF THE DRAWINGS

Referring to the exemplary drawings, wherein like elements are numbered alike in the several Figures:

FIGS. 1-4 illustrate examples of displays of a static graphic image with associated HTML text on a web page according to exemplary embodiments.

FIG. 5 illustrates a method for visually associating a static graphic image with HTML text on a web page according to an exemplary embodiment.

FIG. 6 illustrates a system for visually associating a static graphic image with HTML text on a web page according to an exemplary embodiment.

### DETAILED DESCRIPTION OF EXEMPLARY EMBODIMENTS

Before assistive imagery, a static graphic image on a website was not visually associated with specific copy (HTML text) or content within the same web page or website. According to an exemplary embodiment, using assistive imagery, the user gains visual association between a graphic, an area of a graphic, and/or a process being illustrated in the graphic to copy (HTML text) within that web page or web site that describes or outlines such a graphic or process within that graphic.

Assistive imagery works in both directions, where existing methods, such as an image map and HTML anchor links, work in only one direction. With assistive imagery, the visual association can be triggered from the graphic, image map area of the graphic, the HTML text (not a part of the graphic), or tab index or HTML “in-focus” area. There is no need for the user to mouse click on the graphic to trigger the visual association. This automatically occurs when the user's mouse causes the cursor to be placed over the graphic, over an image map defined are of the graphic, over a text paragraph that describes the graphic or process illustrated within the graphic, or when either text or image is “in focus”. A benefit of showing this visual cue between image and text is that it provides immediate context to what is being illustrated within the graphic, be it a process or action that is being depicted in the graphic. There is no dependency on translation of text either, as the code that provides the function does not focus on language, but rather Cascading Style Sheets (CSS) defined classes, HTML and JavaScript. Thus, for example, the graphic and text may be translated into any language, be it French, German, or any other language, and still retain the visual cue from image to text.

Assistive imagery works by showing a visual association between a static graphic (*.gif,.*.jpeg, *.png or other browser supported bitmap image) and HTML text. Assistive imagery is triggered by user interaction of the mouse over key areas of the graphic, the entire graphic or by user interaction of the mouse over HTML text of by the “in-focus” area as defined by a set of “tabindex” in the HTML code of by the default page “tabindex” focus.

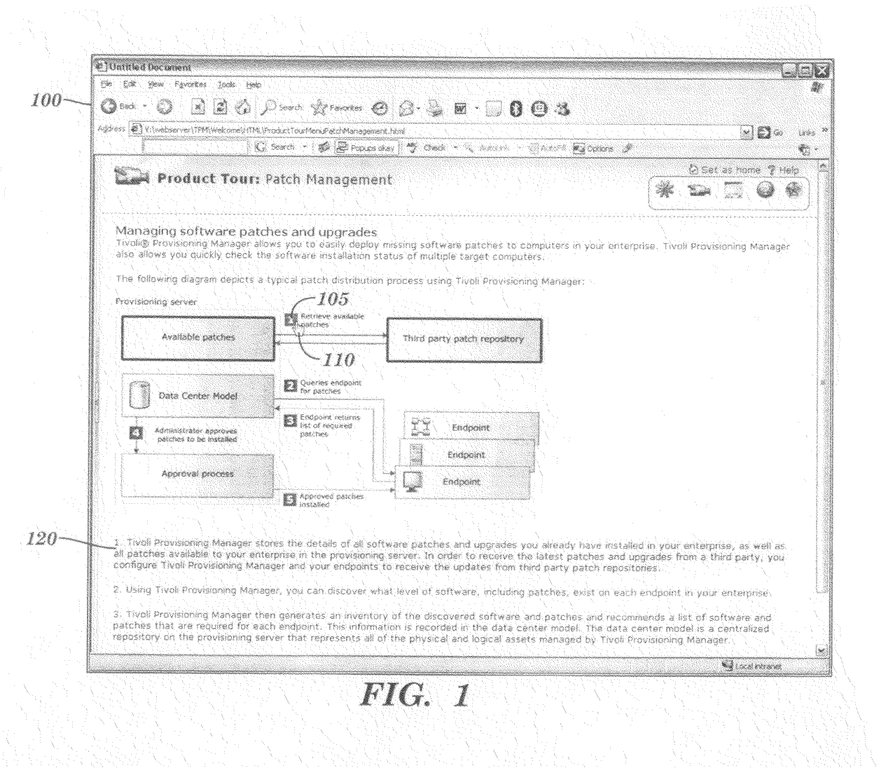

As a first example of visual association according to an exemplary embodiment, FIG. 1 shows a web page including graphic images and HTML text associated with the graphic images. When a user places a cursor over a portion of a graphic image in the web page 100, such as the box 105 with the number “1” inside it, the image displayed is updated to reflect that the image denoted by the box 105 has been selected via cursor movement over the box. The image, including the boxes labeled “Available patches” and “Third party patch repository”, the lines interconnecting the boxes, and the box 105 may be highlighted or displayed using a color different from that used to display these graphics in the original display. At the same time, assistive imagery provides a visual cue by highlighting the HTML text associated with the graphic image. In FIG. 1, the text portion 120 is highlighted, as it is associated with the graphic image including the box 105 and describes the process shown in the graphic. In this case, the visual cue changes the CSS system property of the paragraphs of text to provide the cue that a particular paragraph is associated with the selected graphic image. According to an exemplary embodiment, the selected graphic image and the associated HTML text may be displayed on the same web page at the same locations where they were originally displayed. This is an improvement over pre-existing techniques that required either moving to another web page or another portion of a web page to view HTML text associated with a graphic image.

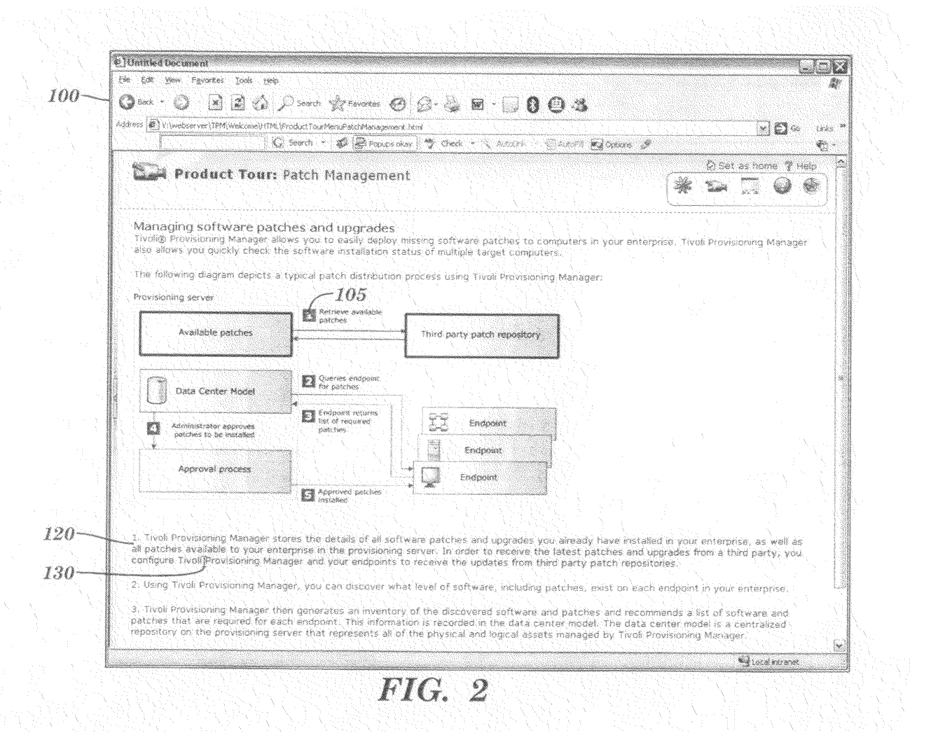

In FIG. 2, the same web page illustrated in FIG. 1 is shown. However, in FIG. 2, a user has moved a cursor 130 over the HTML text 120, causing the HTML text 120 to be highlighted. At the same time, the displayed graphic image associated with the HTML text 120 (including the boxes labeled “Available patches” and “Third party patch repository”, the lines interconnecting the boxes, and the box 105) may be updated, e.g., by displaying it using a color different from that used to display the graphic in the original display. This indicates that the graphic image is associated with the highlighted text. Thus, the end result of the example shown in FIG. 2 is much the same as that shown in FIG. 1, the difference being that the highlighting of the text paragraph and the updated display of the graphic image was triggered by moving the cursor over the text paragraph instead of the graphic image.

For accessibility reasons, if the user cannot use a mouse (or does not desire to do so), a screen reader program or tab index may be used to set focus on either the graphic image or text paragraph. As those skilled in the art will appreciate, a screen reader program is software that enables voice automated reading and description of what is displayed on screen. JAWS is a popular Windows based screen reader application, details of which may be found at. http://www.freedomscientific.com/fs_products/software_jaws.asp. In either case, the same result and visual cue would be provided between the graphic image and the text paragraph that is associated with the graphic image and describes the graphic image. The function of tab indexing to focus on the area of the graphic image or the HTML text may be defined in HTML code or based on a default web page tab index.

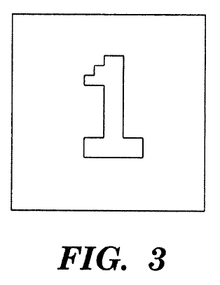

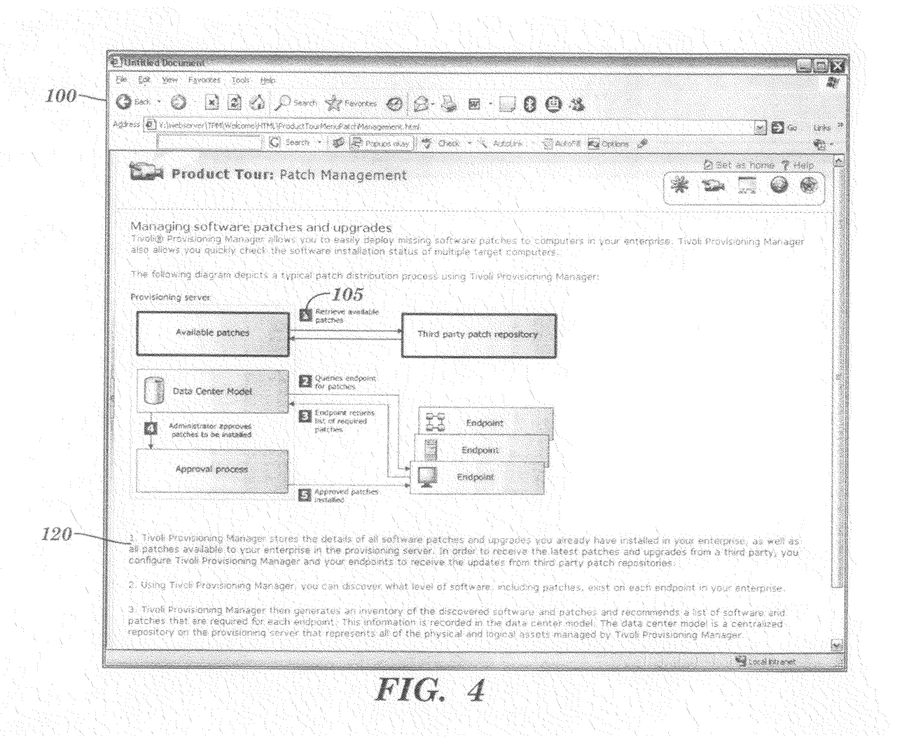

FIG. 3 illustrates an example of a result of using a tab key, touch screen, or some other equivalent peripheral pointer device to focus on a graphic, {e.g., the box 105 shown in FIGS. 1 and 2). Focusing on this graphic image causes the web page illustrated in FIG. 4 to be shown. The web page shown in FIG. 4 is similar to that shown in FIGS. 1 and 2, with the graphic image display updated, and the associated HTML text highlighted on the same web page Although not shown, it should be appreciated that tab-indexing, touch-screening, etc., may also be used to focus on the HTML text, causing the HTML text to be highlighted and the display of the associated graphic image to be updated, as appropriate.

Although in the examples described above, the HTML text paragraph associated with a graphic image is highlighted, e.g., with a different color, to show its association with the graphic image, it should be appreciated that the HTML text may be “highlighted” with any type of visual cue to indicate the association between the HTML text and the graphic image.

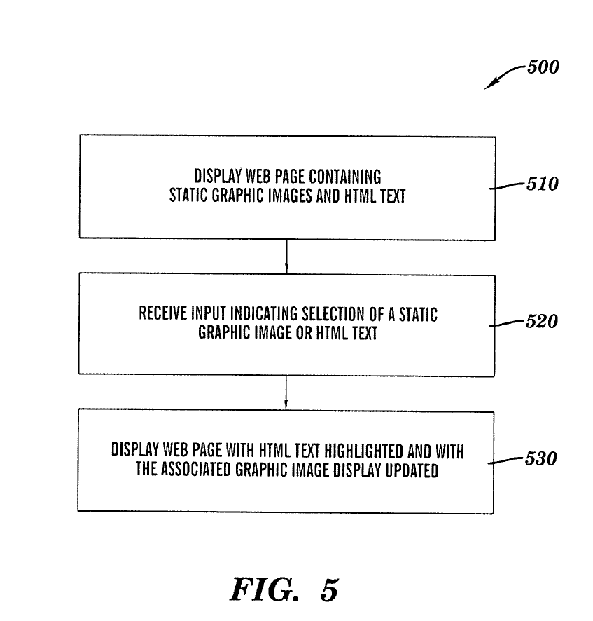

FIG. 5 illustrates a method 500 for visually associating a static graphic image with HTML text on a web page according to an exemplary embodiment. The method begins at step 510 at which a web page containing one or more static graphic images and HTML text is displayed. Each graphic image is associated with certain HTML text on the web page. At step 520, input is received indicating that a static graphic image or HTML text has been selected, e.g., via cursor movement or at least a portion of a static graphic image or HTML text or by focusing on an area of a static graphic image or HTML text. At step 530, the web page is displayed with selected HTML text or HTML text associated with a selected static graphic image highlighted with a visual cue and with the selected graphic image or the graphic image associated with the selected HTML text displayed in an updated manner.

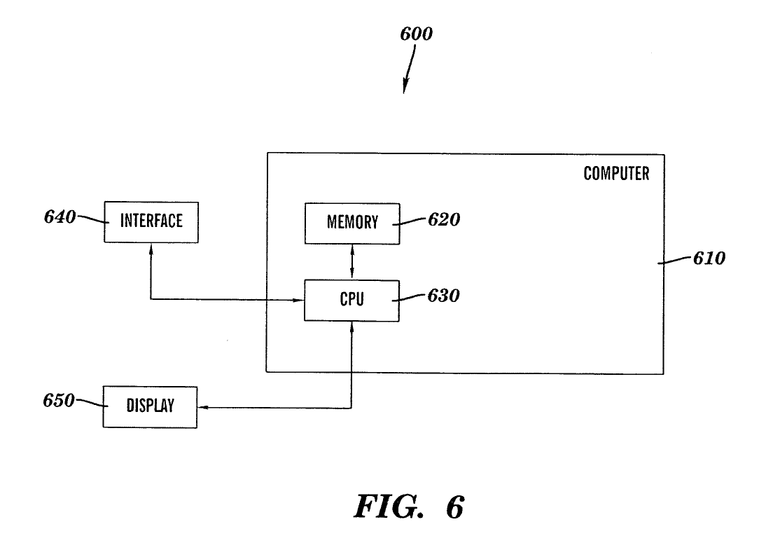

FIG. 6 illustrates an exemplary system for visually associating a static graphic image with HTML text on a web page according to an exemplary embodiment. The system includes a computer 600, e.g., a PC. The computer 600 is in contact with a network (not shown), such as a Wide Area Network (WAN) or the Internet, via wireless or wireline connection. In response to user input via an interface 640, the computer causes a web page to be displayed on a display 650, e.g., a screen. The interface 640 may include, e.g., a keyboard. Alternatively, the interface 640 and the display 650 may be implemented as a single device (e.g., a GUI), and input may be received via touch-screen.

In response to input from the interface 640 indicating selection of a graphic image or HTML text displayed on a web page, a CPU 620 performs a process, such as that described in FIG. 5, for updating the display 650 to highlight HTML text and update the display of the associated static graphic image, as appropriate. The CPU 620 may perform this process using instructions encoded a computer readable medium, such as CD-ROM or floppy disk. These instructions may be read from the computer readable medium, stored e.g., in a memory 610 and retrieved by the CPU 620 as necessary. Alternatively, these instructions may be included as logic within the computer, e.g., as an ASIC.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for visually associating static graphic images on a web page with hypertext markup language (HTML) text on the web page, the method comprising:
displaying on a screen a web page containing multiple static graphic images and HTML text, wherein each static graphic image is associated with certain HTML text on the web page;
receiving input indicating selection of a static graphic image or HTML text, wherein the selection is indicated by movement of a cursor over at least a portion of a selected static graphic image, movement of the cursor over selected HTML text, or focusing on an area of a selected static graphic image or selected HTML text, and
in response to the input, displaying the web page with selected HTML text or HTML text associated with a selected static graphic image highlighted with a visual cue on the web page and with the display of a selected static graphic image or a static graphic image associated with selected HTML text updated without moving to another area on the web page or moving to another web page.

2. The method of claim 1, wherein focusing on the area of the static graphic image or the HTML text includes touching a portion of the screen or performing a tab-indexing function defined in HTML code or based on a default web page tab index.

3. The method of claim 1, wherein the HTML text associated with the static graphic image explains a process illustrated in the static graphic image.

4. A system for visually associating static graphic images on a web page with HTML text on the web page, the system comprising:
a display screen for displaying a web page containing multiple static graphic images a and HTML text associated with each static graphic image;
an interface for receiving input indicating selection of a static graphic image or HTML text, wherein the selection is indicated by movement of a cursor over at least a portion of a selected static graphic image, movement of the cursor over selected HTML text, or focusing on an area of a selected static graphic image or selected HTML text; and
a processor for receiving the input from the interface, wherein, in response to the input, the processor causes the display to display the web page with selected HTML text or HTML text associated with a selected static graphic image highlighted with a visual cue on the web page and with the display of a selected static graphic image or a static graphic image associated with selected HTML text updated without moving to another area on the web page or moving to another web page.

5. The system of claim 4, wherein focusing on the area of the static graphic image or the HTML text includes touching a portion of the screen or performing a tab-indexing function defined in HTML code or based on a default web page tab index.

6. The system of claim 4, wherein the HTML text associated with the static graphic image explains a process illustrated in the static graphic image.

7. A computer program product for visually associating multiple static graphic images on a web page with hypertext markup language (HTML) text on the web page, comprising a computer usable medium having a computer readable program, wherein the computer readable program, when executed on a computer, causes the computer to:
present for display on a screen a web page containing multiple static graphic images and HTML text associated with each static graphic image;
receive input indicating selection of a static graphic image or HTML text, wherein the selection is indicated by movement of a cursor over at least a portion of a selected static graphic image, movement of the cursor over selected HTML text, or focusing on an area of a selected static graphic image or selected HTML text, and
in response to the input, present for display the web page with selected HTML text or HTML text associated with a selected static graphic image highlighted with a visual cue on the web page and with the display of a selected static graphic image or a static graphic image associated with selected HTML text updated without moving to another area on the web page or moving to another web page.

8. The computer program product of claim 7, wherein focusing on the area of the static graphic image or the HTML text includes touching a portion of the screen or performing a tab-indexing function defined in HTML code or based on a default web page tab index.

9. The computer program product of claim 7, wherein the HTML text associated with the static graphic image explains a process illustrated in the static graphic image.
